(19) United States
(12) Patent Application Publication
(10) Pub. No.: US 2021/0165552 A1
(43) Pub. Date: Jun. 3, 2021

(54) USER INTERFACE APPARATUS AND METHOD FOR OPERATION

(71) Applicants: Stein Olav Revelsby, Los Angeles, CA (US); Ziad Badarneh, Oslo (NO)

(72) Inventors: Stein Olav Revelsby, Los Angeles, CA (US); Ziad Badarneh, Oslo (NO)

(21) Appl. No.: 17/022,517

(22) Filed: Sep. 16, 2020

(30) Foreign Application Priority Data
Dec. 3, 2019 (NO) 20191432

(51) Int. Cl. G06F 3/0481; G06F 3/0482; G06F 3/0488; G06F 3/01; G06F 3/16; G06N 20/00

(52) U.S. Cl. CPC G06F 3/04812; G06F 3/04817; G06F 3/0482; G06N 20/00; G06F 3/016; G06F 3/017; G06F 3/167; G06F 3/0488

(57) ABSTRACT

A user interface apparatus is provided that includes a computer arrangement coupled to a data memory arrangement for processing, accessing and storing data, and a display arrangement for receiving graphics data from the computer arrangement to present as graphical images to a user. The computer arrangement, when in operation, instructs the display arrangement to present at least one tesseract with overlayed icons onto facets or layers of the at least one tesseract that represent a menu of executable options that can be invoked by the user. The user interface apparatus is beneficially capable, when in operation, of displaying text, images, presentations. Moreover, the user interface apparatus is capable, when in operation, of supporting personalized interactivity through using machine learning (ML) or artificial intelligence (AI) algorithms executed on the computer arrangement, wherein the personalized interactivity is adapted to take into account personal characteristics and nuances of the user.

### RELATED CASES

The present application claims priority to Norwegian Patent Application No. 20191432, filed Dec. 3, 2019, the disclosure of which is hereby incorporated herein in its entirety.

### TECHNICAL FIELD

The present disclosure relates generally to user interface apparatus for computing systems, wherein the user interface apparatus is configured to access data in a database arrangement, wherein the user interface apparatus is more intuitive when in use, and provides more efficient and responsive access to data in the database arrangement. Moreover, the present disclosure relates to methods for operating aforesaid user interface apparatus. Moreover, the present disclosure relates to a software tool for project control, wherein the aforesaid user interface apparatus is used to provide a user interface to the software tool. Furthermore, the present disclosure relates to computer program products to execute the aforementioned methods.

### BACKGROUND

Although mathematic methods as such are excluded from patent protection in many parts of the World, apparatus whose design has been inspired by mathematical methods are susceptible to benefitting from patent protection when applied to practical use. Decision T 0208/84 (Vicom) defines this principle.

In conventional computer systems, there are provided user interfaces that provide access to file management software tools for inspecting data files and software applications that are available for access or execution on the computer systems; such user interfaces, for example, employ computer mice, joysticks, data entry pads and so forth. Such data files are often presented as long lists and sub-lists, for example arranged alphabetically or arranged in chronological order. However, such lists do not represent an interrelation between the files and applications unless users of the convention computer systems have taken measures when naming files and applications that an interrelationship is apparent from file names. However, when the files are stored in data memory, there is often a lack of any information that interrelates the files.

In view of files being stored in data storage media, for example on a hard-disk drive (HDD) or solid-state drive (SSD), in a manner that does not take into account their mutual interrelation, time to access the files and then relate the files to a desired topic is often sub-optimal, resulting in much searching, confusion and slow response in such conventional computer systems.

### SUMMARY

The present disclosure seeks to provide an improved user interface apparatus for a computer system, wherein the user interface apparatus is configured to provide a user interface that is more intuitive to use and allows for more rapid interaction with the computer system.

Moreover, the present disclosure seeks to provide an improved method for (namely, method of) operating the improved user interface apparatus, providing a user interface that is more intuitive to use and allows for more rapid interaction with the computer system.

Furthermore, the present disclosure seeks to provide a computer program product to execute a method for operating the improved user interface in combination with the computer system.

In a first aspect, the present disclosure provides a user interface apparatus including a computer arrangement coupled to a data memory arrangement for processing, accessing and storing data, and a display arrangement for receiving graphics data from the computer arrangement to present as graphical images to a user, characterized in that the computer arrangement, when in operation, instructs the display arrangement to present at least one tesseract including facets or layers with overlayed icons thereonto that represent a menu of executable options that can be invoked by the user.

The present invention is of advantage in that use of the at least one tesseract with facets or layers to determine a manner of information presentation on the display arrangement to the user provides for more efficient user interaction with the user interface apparatus in an intuitive manner, with less user fatigue and faster user response.

Optionally, when the user interface apparatus is in operation, the overlayed icons on neighbouring facets or layers of the at least one tesseract are related by a similarity of nature of data that their icons represents, and a likely temporal sequence in which the icons are to be invoked by the user when using the user interface apparatus.

More optionally, when the user interface apparatus is in operation, the at least one tesseract is displayed on the display arrangement in 2-dimensions, wherein the at least one tesseract represents more than 3-dimensions in its geometric structure.

More optionally, when the user interface apparatus is in operation, the at least one tesseract, when displayed via the display arrangement, is susceptible to being rotated in response to feedback provided to the user interface apparatus by the user

More optionally, when the user interface apparatus is in operation, the feedback provided to the user interface apparatus by the user includes at least one of: touch feedback provided via the display arrangement when implemented using a touch screen with tactile sensing, oral feedback captured using a microphone of the user interface apparatus, gesture feedback of the user captured via use of a camera of the user interface apparatus.

Optionally, when the user interface apparatus is in operation, data used by the user interface apparatus is stored in the data memory arrangement according to icons on neighbouring facets or layers of the at least one tesseract that is presented, when the user interface apparatus is in operation, on the display arrangement.

Optionally, the user interface apparatus is configured to implement a workspace platform for user interaction, wherein the workspace platform, when executed in operation, provides a presentation plan in which a plurality of elements are representative of projects, parts of projects, information supporting projects, and wherein one or more linking arrows are included on the plan to represent interrelationships between the elements.

More optionally, in the user interface apparatus, at least one of the elements, the linking arrows and the information supporting projects is user-editable via the workspace platform.

More optionally, in the user interface apparatus, the workspace platform is configured to support multiple users that are able mutually interactively to access and interrogate the work platform.

In a second aspect, the present disclosure provides a method for operating a user interface apparatus including a computer arrangement coupled to a data memory arrangement for processing, accessing and storing data, and a display arrangement for receiving graphics data from the computer arrangement to present as graphical images to a user,

characterized in that the method includes:

arranging for the computer arrangement, when in operation, to instruct the display arrangement to present at least one tesseract including a menu layer with overlayed icons onto facets or layers of the at least one tesseract that represent a menu of executable options that can be invoked by the user.

Optionally, the method includes relating overlayed icons on neighbouring facets or layers of the at least one tesseract by a similarity of nature of data that their icons represents, and a likely temporal sequence in which the icons are to be invoked by the user when using the apparatus.

More optionally, the method includes displaying the at least one tesseract with its facets or layers on the display arrangement in 2-dimensions, wherein the at least one tesseract represents more than 2-dimensions in its geometric structure.

More optionally, the method includes arranging for the at least one tesseract with its layers or facets, when displayed via the display arrangement, to be susceptible to being rotated, (for example pitched, rolled, and yawed) in response to feedback provided to the apparatus by the user.

More optionally, in the method, the feedback provided to the user interface apparatus by the user includes at least one of: touch feedback provided via the display arrangement when implemented using a touch screen with tactile sensing, oral feedback captured using a microphone of the apparatus, gesture feedback of the user captured via use of a camera of the user interface apparatus.

Optionally, the method includes storing data used by the user interface apparatus in the data memory arrangement according to icons on neighbouring facets or layers of the at least one tesseract that is presented, when the user interface apparatus is in operation, on the display arrangement. Thereby, the method provides an intuitive human-machine interface (HMI).

Optionally, the method includes configuring the user interface apparatus to implement a workspace platform for user interaction wherein the workspace platform, when executed in operation, provides a presentation plan in which a plurality of elements are representative of projects, parts of projects, information supporting projects, and wherein one or more linking arrows or drawing aids are included on the plan to represent interrelationships between the elements.

More optionally, in the method, at least one of the elements, the linking arrow and the information supporting projects is user-editable via the workspace platform.

More optionally, the method includes configuring the workspace platform to support multiple users that are able mutually interactively to access and interrogate the work platform.

In a third aspect, embodiments of the present disclosure provide a computer program product comprising a non-transitory (namely, non-transient) computer-readable storage medium having computer-readable instructions stored thereon, the computer-readable instructions being executable by a computerized device comprising processing hardware to execute the aforementioned method pursuant to the aforementioned second aspect.

Optionally, the computer program product includes machine learning (ML)/artificial intelligence (AI) software products to provide customization of the apparatus of claim 1 to characteristics of its user.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and apparatus disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a user interface apparatus pursuant to the present disclosure; the user interface apparatus is optionally implemented as a mobile communication device, for example as a smart phone;

FIG. 2 is a schematic illustration of an increasing geometrical complexity from a 2-dimensional graphical user interface (GUI) system to a tesseract including facets or layers as an interconnected arrangement;

FIG. 3 is a schematic illustration of a tesseract represented as a configuration of nodes with interconnection links provided between the nodes;

FIG. 4 is a schematic illustration of an alternative form of tesseract as a configuration of nodes with interconnection links provided between the nodes;

FIG. 5 is a schematic illustration of a more complex polygonal tesseract as a configuration of nodes with interconnection links provided between the nodes;

FIG. 6 is a schematic illustration of a manner of navigating nodes of a tesseract structure to obtain information, in an intuitive manner, pertaining to the nodes;

FIG. 7 is a schematic illustration of a menu system for a user interface of the user interface apparatus of FIG. 1, wherein the menu system is intuitively based on a tesseract form;

FIG. 8 is a schematic illustration of the menu system of FIG. 7 implemented on a touch-screen of a contemporary smart phone;

FIG. 9 is an illustration of the user interface apparatus of FIG. 1 implemented as a smart phone/tablet/PC, wherein the user interface apparatus is provided with software products for enabling a user profile to be stored on the user interface apparatus, for example user images, user voice profile, user preferences, user nuances, user movement characteristics;

FIG. 10 is an illustration of the user interface apparatus of FIG. 1 implemented as a smart phone/tablet/PC, wherein the user interface apparatus is provided with software products for enabling the user interface apparatus to characterize gesture nuances and characteristics of its user;

FIG. 11 is a 1-dimensional menu function that a user is able to employ in contemporary software applications, wherein the menu function has a main menu and sub-menus that can be invoked;

FIG. 12 is an illustration of implementing the 1-dimensional menu function of FIG. 11 by way of using a tesseract representation, wherein the tesseract representation is susceptible to being user-manipulated to select various functions;

FIG. 13 is an illustration of use of the tesseract representation of FIG. 12 as an alternative or addition to a 1-dimensional menu, wherein the tesseract representation allows rapid access to a “workspace” platform into which various planning functions and projection representations can be input and processed by way of interlinking representation objects by way of linking arrows;

FIGS. 14, 15 and 16 are illustrations of use of the tesseract representation in the workspace platform;

FIG. 17 is an illustration of a flowchart of project management of a given project, as presented using the “workspace” platform;

FIG. 18 is an illustration of the tesseract representation of FIG. 12 illustrating its multi-faceted geometric form;

FIG. 19 is an illustration of use of the tesseract representation in a personal training application wherein the tesseract representation can be used to convey different facets of a given person's personality and physical form; and

FIG. 20 is an illustration of a software application context in which the tesseract representation of FIG. 12 is susceptible to being used.

In the accompanying diagrams, an underlined number is employed to represent an item over which the underlined number is positioned or an item to which the underlined number is adjacent. A non-underlined number relates to an item identified by a line linking the non-underlined number to the item.

### DETAILED DESCRIPTION OF EMBODIMENTS

In the following detailed description, illustrative embodiments of the present disclosure and ways in which they can be implemented are elucidated. Although some modes of carrying out the present disclosure is described, those skilled in the art would recognize that other embodiments for carrying out or practicing the present disclosure are also possible.

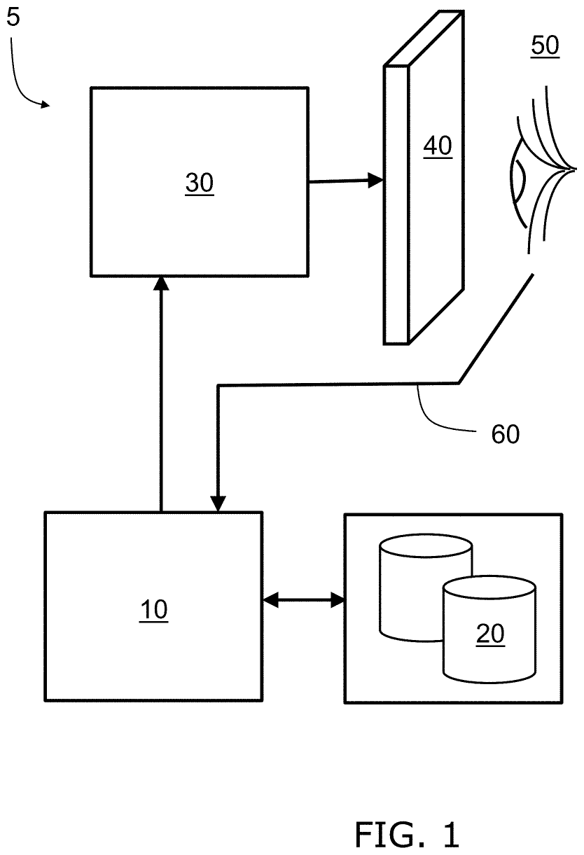

Referring to FIG. 1, there is shown a schematic illustration of a user interface apparatus 5 pursuant to the present disclosure. The user interface apparatus 5 includes a computer arrangement 10 that is communicatively coupled to a database arrangement 20; the database arrangement 20 includes a data storage medium on which files of data are stored. The computer arrangement 10 is coupled to a graphics generation arrangement 30 that receives, when in operation, output data from the computer arrangement 10, for example images to be rendered or text to be rendered. The graphics generation arrangement 30 is coupled to a pixel display 40, for example an organic LED pixel display, a pixel liquid crystal display of similar, wherein the pixel display 40, when in operation, presents visual information to a user 50. Optionally, the graphics generation arrangement 30 is implemented in custom hardware, for example a field programmable gate array (FGPA), a custom graphics hardware integrated circuit, or can be implemented using software executed in the computer arrangement 10. Optionally, the graphics generation arrangement 30 includes templates for presenting tesseract images on the pixel display 50 with icon overlays, and also includes algorithms (for example, implemented in hardware of a FPGA) for generating geometrically rotated versions of the tesseract images.

When in operation, the computer arrangement 10 of the apparatus of FIG. 1 accesses data in the database arrangement 20 as well as receiving data that is received externally, for example via a wireless interface (not shown). The computer arrangement 10 outputs graphics data to the graphics generation arrangement 30 that processes the graphics data to generate an output image composition that is presented via the pixel display 40 to the user 50. The user 50 interacts back to the computer arrangement 10, for example via a touch-screen functionality 60 of the pixel display 40, to cause the computer arrangement 10 to implement further functions, as will be described in greater detail later. The user interface apparatus utilizes a tesseract manner of operation that makes interfacing of the user 50 to the user interface apparatus 5 much faster and intuitive in comparison to a manner in which conventional user interfaces function.

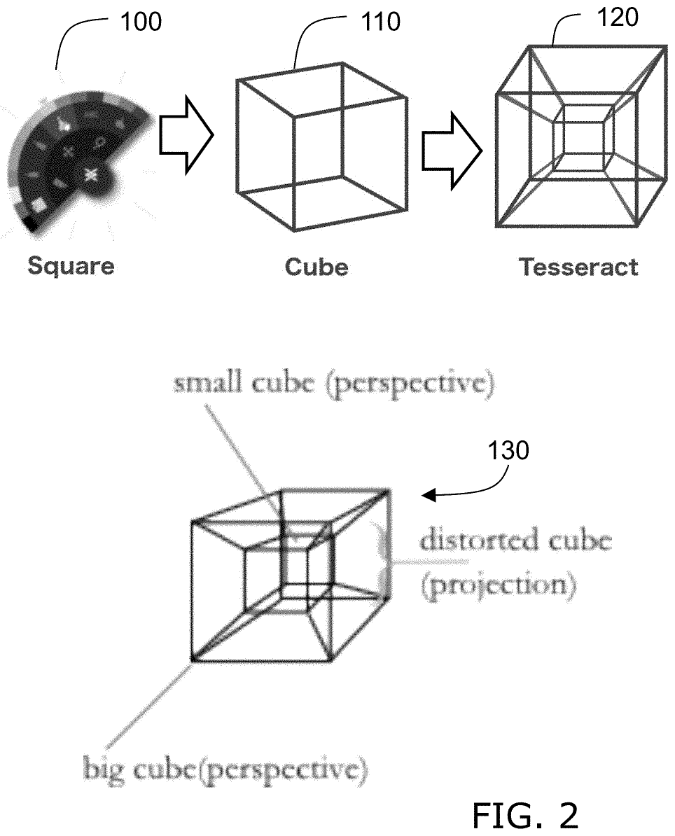

Referring next to FIG. 2, there is shown a progression of geometrical form from a 2-dimensional square 100 to a 3-dimensional cube 110 (represented in 2-dimensions) and finally to high-order dimension tesseract 120, 130 (also represented in 2-dimensions). The tesseract 120 is capable of representing, for example 3 Cartesian coordinates and temporal coordinates. The tesseract 120 can be represented as a configuration of nodes at intersects of lines, as indicated by 130, wherein the lines represent boundaries that define logical or functional links between elements, concepts or cognitive constructs represented by the nodes.

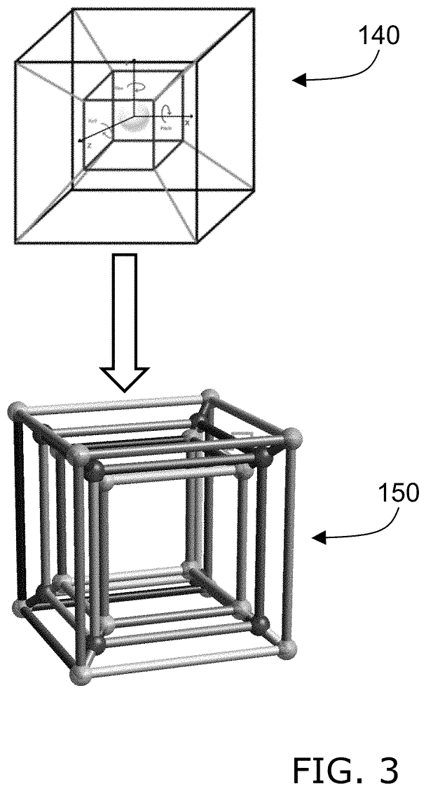

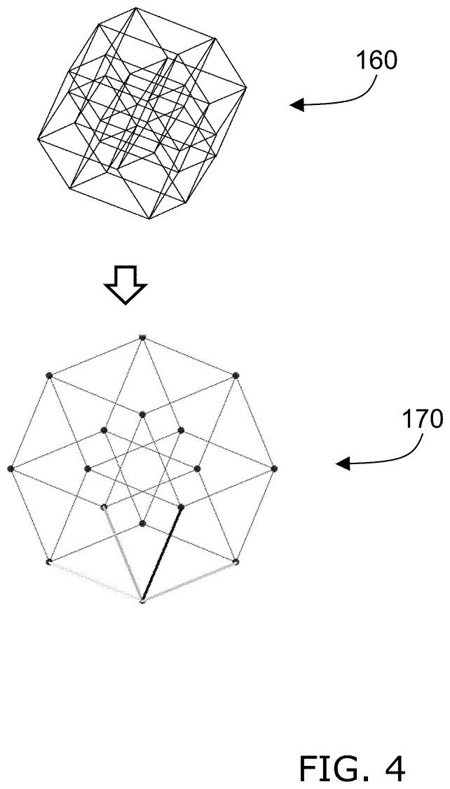

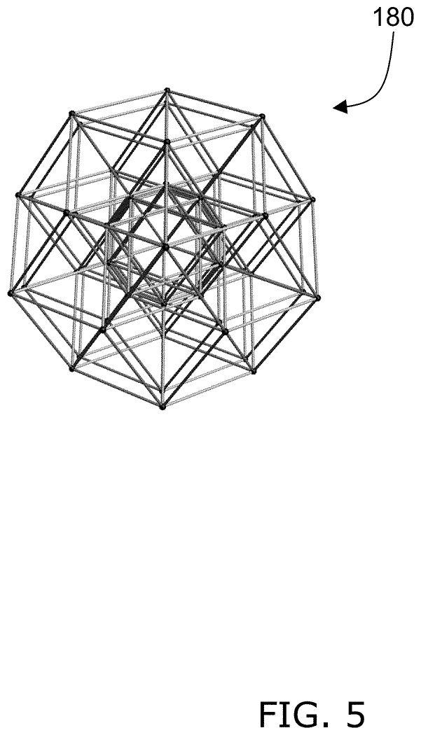

Referring next to FIG. 3, various concepts, objects or topics can be represented by graphical symbols associated with various facets, for example layers, of the tesseract 120, 130, as indicated by 140; the tesseract 140 can be represented as a configuration of nodes and lines as indicated by 150, as described in the foregoing. As shown in FIG. 4, embodiments of the present disclosure are not limited to cube-based tesseracts, and other geometrical forms can be a basis of how the user interface apparatus is structured in its manner of operation; for example a complex hexagonal-base tesseract 160 has a node and line interconnection as indicated by 170. In FIG. 5, a high-order tesseract is depicted that can be used to navigate a complex conceptual space using the user interface apparatus 5.

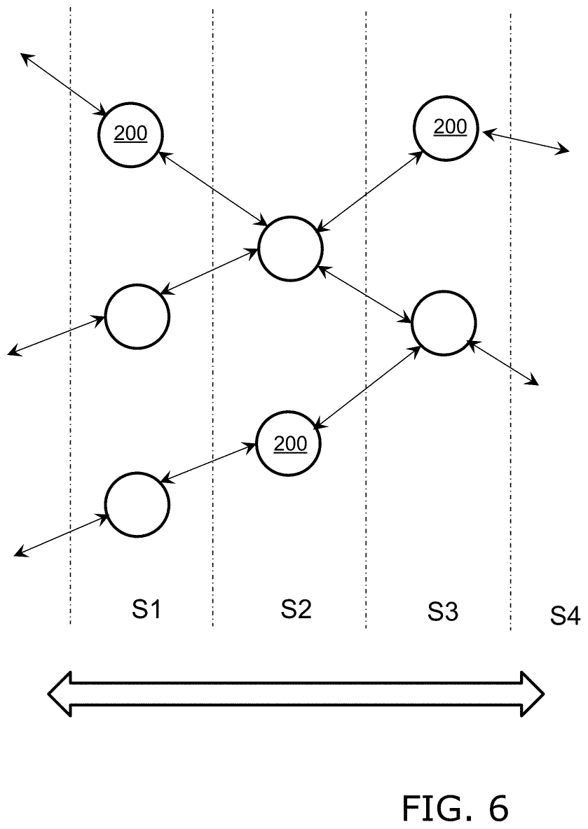

When the user 50 employs the user interface apparatus 5, the user 50 navigates around facets of a tesseract depicted in 2-dimensions on the pixel display 40. As the user 50 invokes a given facet of the tesseract by touching the pixel display 40 or moving a mouse cursor over the given facet or layer presented on the pixel display and then clicking on the mouse cursor, neighbouring facets or layers are shown surrounding the selected given facet. Such a transition between related neighbouring facets or layers is depicted in FIG. 6, wherein steps of interrogating the tesseract are denoted by S1 to S4. The user 50 can move backwards and forwards through facets or layers of the tesseract to search interrelations between concepts or data elements represented by the facets; the facets or layers are denoted by nodes 200.

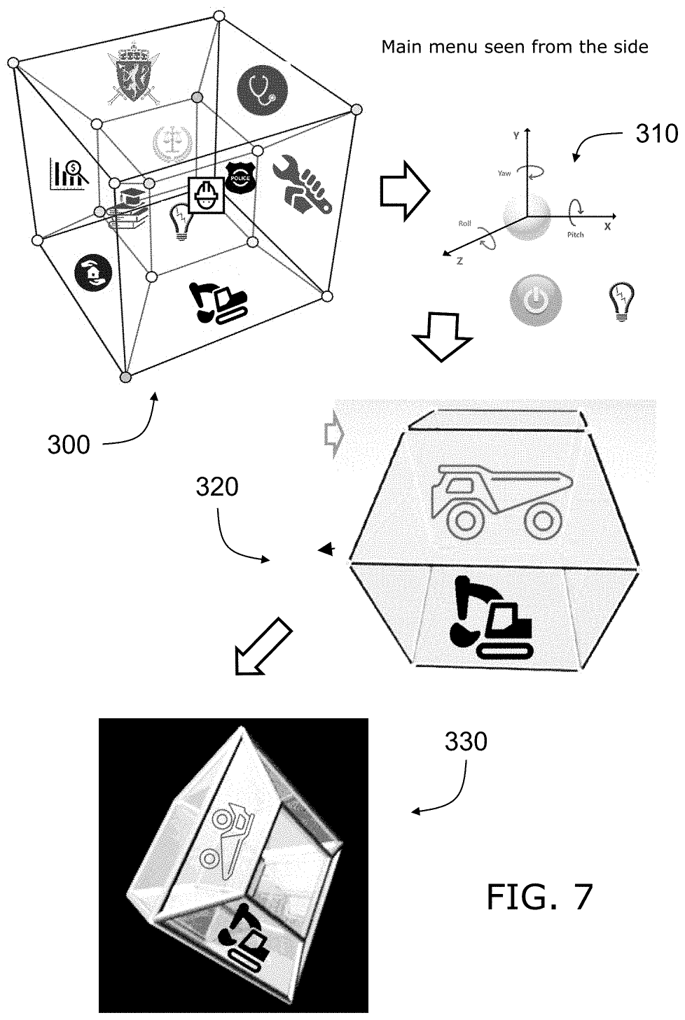

Referring next to FIG. 7, a main menu is presented by the user interface apparatus 5 on the pixel display 40 to the user 50, wherein choices in the menu are represented by symbols overlaid in perspective view onto facets, namely layers, of the tesseract. The user 50 is able to use the user interface apparatus 5 to rotate the tesseract on the pixel display 40 in respect of one or more Cartesian axes to find a given facet or layer, having a given type of symbol associated therewith, that is desired by the user 50, wherein neighbouring facets or layers to the given facet or layer are shown whose subject matter is linked or related to the given facet or layer. Such a manner of representing information on the pixel display 40 is intuitive and immensely helpful to the user, enabling the user 50 to navigate the menu list at a vastly greater speed than would be possible with menu lists or even symbolic menu lists provided in 2-dimensions (e.g. as per Windows® 10 and similar contemporary operating systems). Such greater speed is especially beneficial when the user interface apparatus is used to control equipment in real-time where very fast decision making and responsiveness when decision making is required from the user 50, without the user 50 becoming fatigued or mentally exhausted. It will be appreciated that reducing user fatigue and mental exhaustion are technical effects provided by the user interface apparatus 5 of the present disclosure.

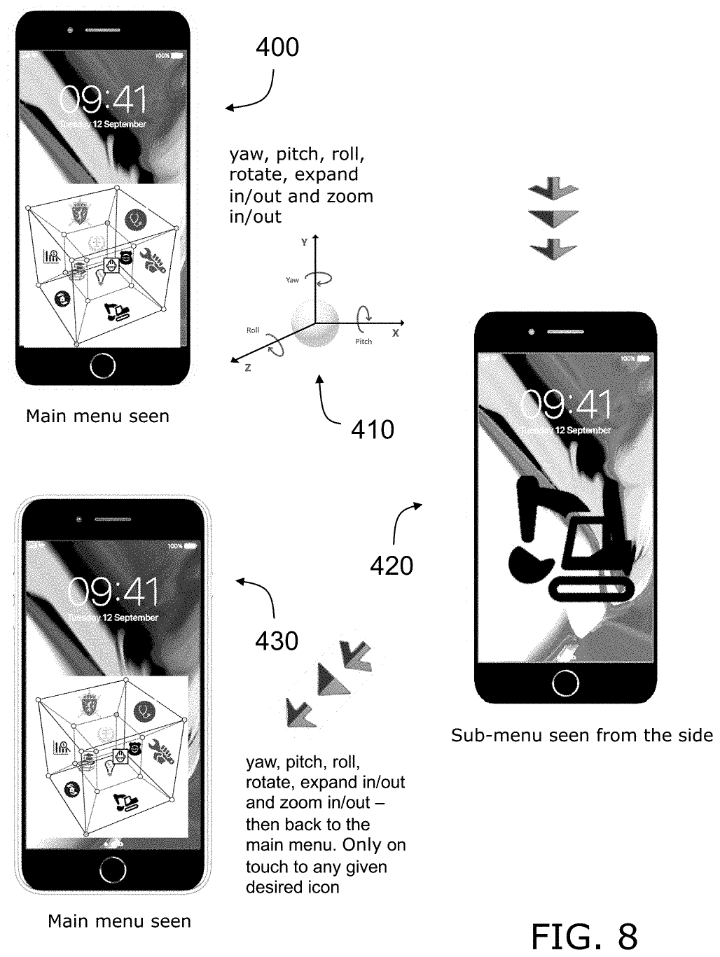

It will be appreciated that the computer arrangement 10 and its associated database arrangement 20 can be implemented as a laptop computer, a dedicated computer-based control terminal, a tablet computer, a portable wireless communication device (for example a smart phone) or similar. For example, the aforesaid user interface apparatus 5 of FIG. 1 is shown in FIG. 8 as being implemented using a software application downloaded to a smart telephone equipped with a touch-screen display.

From the foregoing embodiments of the present disclosure, it will be appreciated that a depiction of a 4-dimensional tesseract is feasible for providing a highly effective user interface on the pixel display 40. Optionally, an increasing number of dimensions can be represented graphically on the pixel display 40 such as a penteract, for example an 8-cell or 5-cube in a 5^{th}-dimensional version of a hypercube, wherein such forms are represented by their physical and mathematical geometrical figures; such an approach of for displaying a memory provides the user not only with a choice of menu options as amongst which to select, but also shows an interrelationship between the menu options in a manner that is instantly appreciated by the user 50 in an intuitive manner.

For example, the apparatus of FIG. 1 beneficially employs an interactive 4-dimensional hypercube or even higher dimensionality such as a penteract to hexeract, for achieving effective data processing, storage, image organizing and projection and thus represent a various forms of effective complex data processing. Data and objects displayed for the user from the hypercubes having capabilities the of yaw, pitch, roll, rotate, expand in/out and zoom in/out. Beneficially, data allocated to data memory of the database arrangement 20 is beneficially also distributed in a manner determined by the tesseract displayed, when the user interface apparatus is in operation, on the pixel display 40; this provides for an optimal distribution of data in the database arrangement 20 that allows for most efficient access to the data; for example data of related neighbouring concepts are stored in a neighbouring manner within the database arrangement 20. Such more efficient organisation of data and user interface is needed in todays' ever expanding data storage, data recognition, electronic data processing, by building complex user interface (UI) layers for logical and fast use, image recognition, personal voice recognition, posture recognition, and such like in all electronic devices.

As is well known, the World as perceived by the human mind is limited to three physical dimensions, that are often represented relative to a Cartesian frame of reference; time is generally attributed to a fourth dimension. However, the three physical dimensions and the temporal dimension are mutually different in their characteristics. The object of the present invention is to make use of esoteric (meaning 4-dimensions and greater, for example via use of penteract, hexeract and similar complex geometries in a practical utility) geometric figures and their corresponding mathematical basis to facilitate more efficient processing, storage and representation of data within computer arrangements.

Example 1: As illustrated in FIG. 2, a 3-dimensional cube can be used to represent any given point in a given region of the natural universe. Should one wish to include the time-dimension, namely any given point at any given time, the model would not suffice. By using hypercubes, for example depicted in 2-dimensions on the pixel display 40, by employing a 4-dimensional tesseract and or a tesseract of even higher dimensionality, the physical spatial and temporal dimensions are susceptible to being seamlessly and efficiently represented as easily as the 3-dimensional cube illustrated in respect of x, y and z-Cartesian axes, as shown. Correspondingly, the computer arrangement 10 made to operate within a framework defined by a 4-dimensional geometrical structure is potentially massively more efficient both in terms of processing, location and storage of data.

Example 2: A hypercube, such as a 4-dimensional tesseract, can include a depiction of both physical spatial location information as well as temporal location information. Should a given person wish to add more variables, the given person simply adds the corresponding number of dimensions to the required variables to the tesseract displayed on the pixel display 40 in 2-dimensions. Thus, in an example, information relating to time, colour and temperature could all fit within one, unified geometrical tesseract-type figure presented on the pixel display 40, for use by the user 50 to navigate information stored within the database arrangement 20, namely device data memory, in a most efficient manner. In other words, a mathematical basis provides an approach to organizing and implementing a data processing system, as was also an important issue when implementing the invention of T0208/84 (Vicom).

The computer arrangement 10, in combination with the database arrangement 20 and the graphics generation arrangement 30, when in operation, provides an Interactive 4-dimensional and haptic UI (user interface) menu structure processed by depictions of multi-dimensional tesseracts, for example hypercubes, having, for example, more than 4-dimensions, but depicted in 2-dimensions on the pixel display 40 to the user 50, wherein manipulation by the user 50 of the multi-dimensional tesseracts is enabled by user-control the data processing arrangement 10; such control is achieved, for example controlled by identifying, for example via use of personalized voice input from the user 50, wherein the computer arrangement 10 is equipped with voice recognition logarithm software (for example by performing Fast Fourier Transform of captured voice signals from a microphone to obtain temporal trajectories of Fourier coefficients and then performing temporal correlation of the Fourier coefficients with pre-programmed or pre-recorded sound templates), to manipulate the tesseract on the pixel display 40 to invoke execution of desired functions of the computer arrangement 10. Although voice control is described as an example, it will be appreciated that other sensory approaches to controlling the tesseract depiction on the pixel display 40 can be employed, for example by sensing (using a camera coupled to the computer arrangement 10) hand gestures of the user 50, for example finger pointing. Alternative methods for controlling the displayed tesseract can optionally include eye control, touch or manipulated by other means.

The interactive 4-dimensional and haptic user interface (UI) menu structure utilized within the apparatus of FIG. 1 organizes itself in a correct order depending on subject and or topic, by grouping together related topics that the user is likely to invoke, for example, in temporal series or logical series. Moreover, the Interactive 4-dimensional and haptic UI menu structure organizes itself by logical order by at least one of: significance “weight” (namely, relevance), words, subject and topic. A desired icon for a given topic, from a given subject, always appears after a given command, that is centered, in an expected portion (namely “central spot”) in the pixel screen 40, predicted by an interactive 3D haptic UI algorithm of the graphics generation arrangement 30, whereat the given object or the user 50 expects the given icon to appear. Furthermore, the interactive 4-dimensional and haptic UI menu structure is designed for use in cell phones, smart phones, televisions (namely “TV”), tablet computers, personal computers (PC's) and any given computer-implemented device having a pixel screen for user interfacing purposes wherein user feedback from images displayed via the pixel screen is expected; for example, the user interface apparatus 5 is beneficially used for interactive graphical user interface (GUI) displays of vehicles (e.g. automobiles) that show various functional features that can be invoked in the vehicles; alternatively, the user interface apparatus 5 is highly effective for assisting users to navigate reports of problems or faults that have developed in vehicles as sensed by sensor arrangements of the vehicles, wherein given facets or layers of the tesseract represent the problems or faults wherein invoking the given facets or layers provide further information relating to a specific nature of the problems or faults, and neighbouring facets or layers to the given facets or layers provide when invoked provide information regarding what can be done to remedy, repair or ameliorate the problems of faults, for example when invoked causing a message to be sent to a roadside assistance support service to send an engineer to the remedy or repair the problem or fault. The interactive 4-dimensional and haptic UI menu structure, UI main menu or submenu are displayed on the pixel screen 40 of the user interface apparatus 5 by utilizing a tesseract, penteract or hexeract image on the pixel screen 40, wherein various gestures of the user, for example body movement or rhythm, are able to manipulate an orientation of the tesseract, penteract or hexeract image to select a desired facet or layer thereof for invoking the computer arrangement to access corresponding data in the database arrangement 20. It will be appreciated that the database arrangement 20 is optionally spatial local to the user interface apparatus 5, spatial remote from the user interface apparatus 5 and accessed via a wireless data connection, or a combination of data memory storage that is spatially local to the user interface apparatus 5 and data memory that is spatially remove from the user interface apparatus 5.

Beneficially, therefore, the user interface apparatus 5 employs interactive 4-dimensional hypercubes displaying in 2-dimensions on the pixel display 40, for implementing a haptic UI, namely a (graphical user interface (GUI), in a logical hierarchical system, displaying main icons that articulate main tasks (namely executable functions) on facets or layers most centrally presented to the user 50 via the pixel display 40, with related tasks represented in neighbouring facets of the 4-dimensional hypercubes.

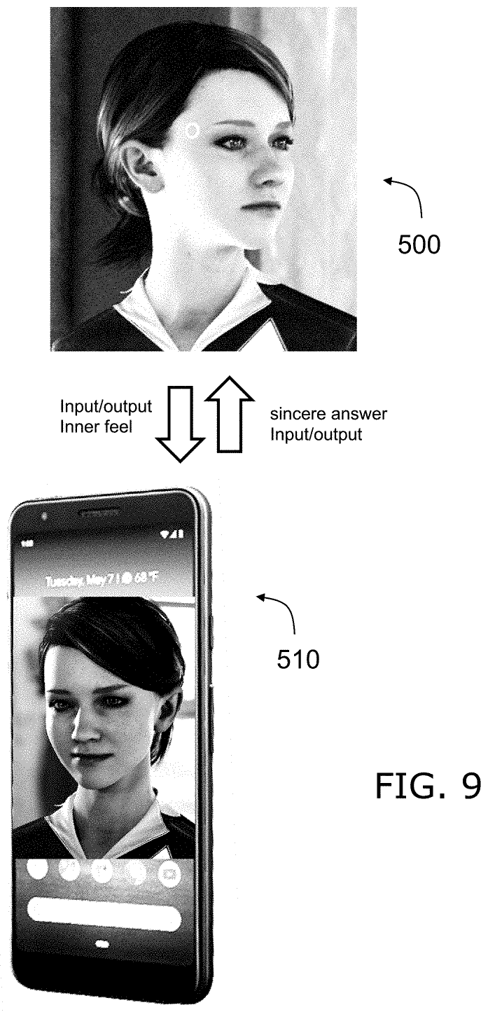

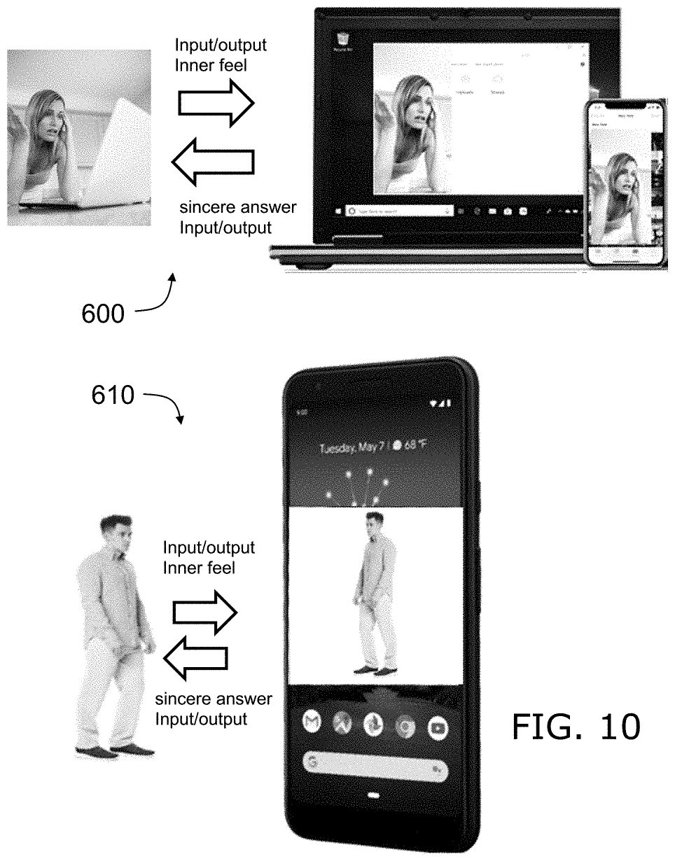

Use of the user interface apparatus 5 of FIG. 1 will next be described with reference to FIGS. 9 and 10. The user interface apparatus 5 employs an operating system that utilizes algorithms, for example based on machine learning (ML) or artificial intelligence (AI) algorithms to achieve following functionalities:

(i) the user interface apparatus 5 adopts a given user's 50 “user pattern” as an input with a desired output through a virtual profile; there is thereby determined the given user's 50 behaviour and psyche;

(ii) the user interface apparatus 5 captures a voice signature (“a MASTER voice”) associated with the given user 50;

(iii) the user interface apparatus 5 captures and evaluates characteristics of the given user's 50 gesticulation for recognition purposes, for example arm gesticulation or way of walking of the given user 50;

(iv) the user interface apparatus 5 employs a machine learning (ML) or artificial intelligence (AI) algorithm to determine what the given user 50 is likely to say or write to determine characteristics of the given user's 50 writing or oral discourse style;

(v) the user interface apparatus 5 employs a machine learning (ML) or artificial intelligence (AI) algorithm to recognize what the given user 50 is likely to say or write, and then makes suggestions for finishing written text before the written text is sent from the user interface apparatus 5;

(vi) the user interface apparatus 5 learns through evaluation of the given user's 50 information regarding the given user's 50 preferred subjects, evaluates the given user 50 likes best, and evaluates what the given user 50 wants;

(vii) the user interface apparatus 5 evaluates the given user's 50 use of words to determine what the given user 50 is seeking to say, seeking to find, and so forth.

The user interface apparatus 5 is capable of creating presentations (PPP) on behalf of the given user 50, for example by specifying only headlines what the given user 50 wants to present by subject/topic, where the given user's 50 profile can create text and place pictures through available data, text, pictures and such like that is available online via an Internet® connection to the user interface apparatus 5. For example, a live document can be created to present a case/topic, where pre-prepared presentations for a given topic is dynamically generated and allocated depending on logical presentations aroused by what the given user 50 is trying to highlight in his/her interactions with the user interface apparatus 5.

Beneficially, in an event of the user interface apparatus 5 being exposed to virus attacks of any kind, especially seeking to steal the virtual personality of the given user 50, the user interface apparatus 5 is automatically transitioned into a sleep state.

Optionally, the aforementioned functionalities (i) to (vii) are controlled by use of a tesseract menu presented via the pixel display 40 to the given user 50. In an event of the user interface apparatus 5 being subject to virus attack, the tesseract menu is disabled.

The aforesaid tesseract 140 of FIG. 3, likewise the tesseract 160 and 170 of FIG. 4, likewise the tesseract 180 of FIG. 5, is beneficially useable as a form of menu structure for interactive software applications, for example for execution on mobile communication devices, for example a smart phone 510 as depicted in FIG. 9. For example, the smartphone 510 using the tesseract 140 via its graphical user interface (GUI) can be used to represent complex emotional states of a given person indicated generally by 500. The tesseracts 140, 160, 170, 180 are beneficially viewable via the GUI to show an interrelationship between traits of a given person. As human interaction is an important part of peoples' lives, being able to present a state of a given person via a tesseract representation allows for people rapidly to access other people's state of wellbeing. Likewise, as illustrated in FIG. 10, a tesseract representation is beneficially useable with software applications executable on both smart phones and personal computers for use in conveying peoples' state of mind, wellbeing, posture and so forth via facets 200 of the tesseract 140, for example.

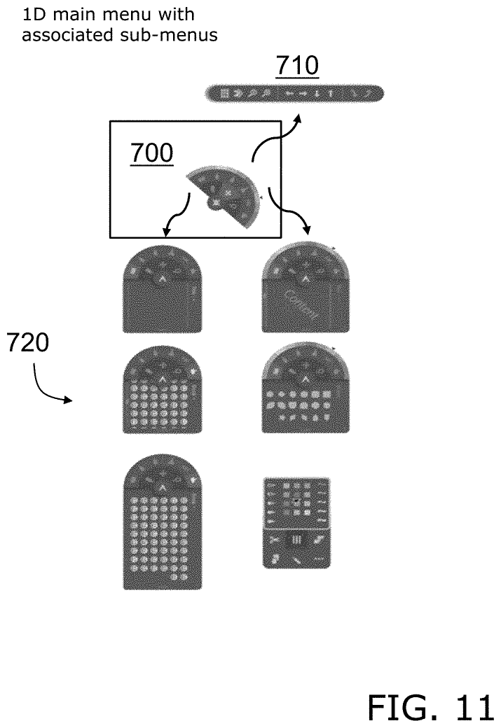

Referring text to FIG. 11, a 1-dimensional menu option is conveniently used in software applications for various tools, for example graphical design tools, project management tools and similar. As illustrated, a menu denoted by 700 has various user-options presented as a fan arrangement, in a manner akin to an artist's palette, namely an arcuate form; by using mouse cursor control, various options of the menu 700 can be invoked for execution. By a given user invoking an option of the menu 700, various sub-menus can be invoked as denoted by 720. As an alternative, rather than employing the fan arrangement, the menu 700 can be provided in a linear menu 710. The linear menu 700 is beneficially employed in a “workspace” software application that uses a graphical representation of key elements in project planning, wherein interrelationships between the elements, and also supporting information for the elements, can be accessed via mouse cursor control of the aforementioned menu 700 in combination with the elements. The elements are conveniently represented by geometric shapes, for example rectangles, on a background plane, wherein the geometric shapes are interlinked with linking arrows, wherein the linking arrows can be user-added and user-edited to represent information elucidating the relationships. Thus, the elements and their linking arrows can be user-interrogated. The menu 700 assists to draw the elements and their linking arrows as well as entering and interrogating information pertaining to the elements and their interrelationships.

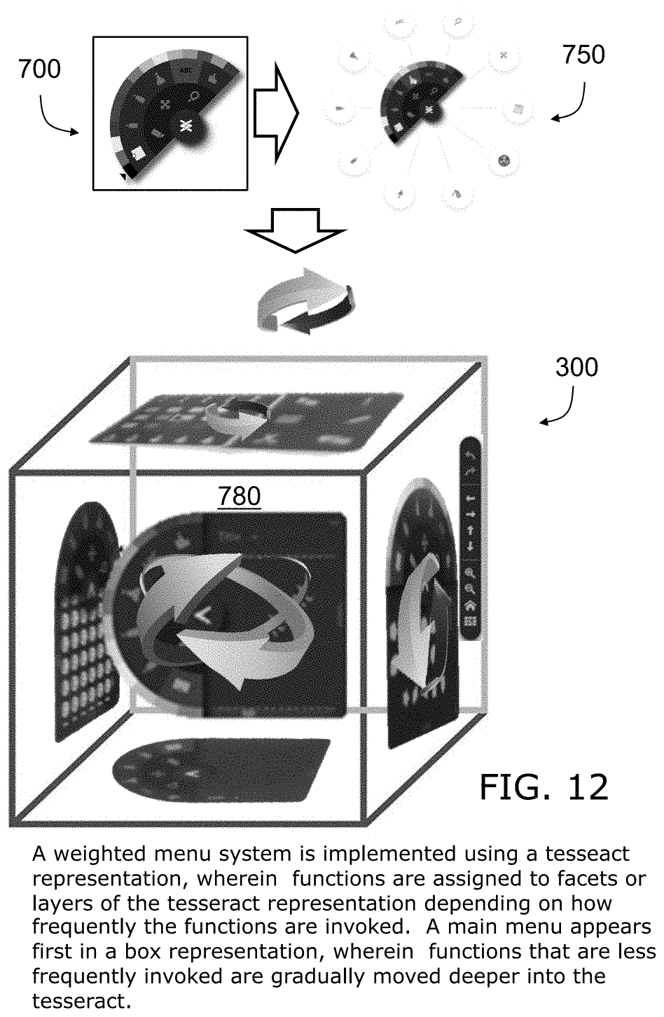

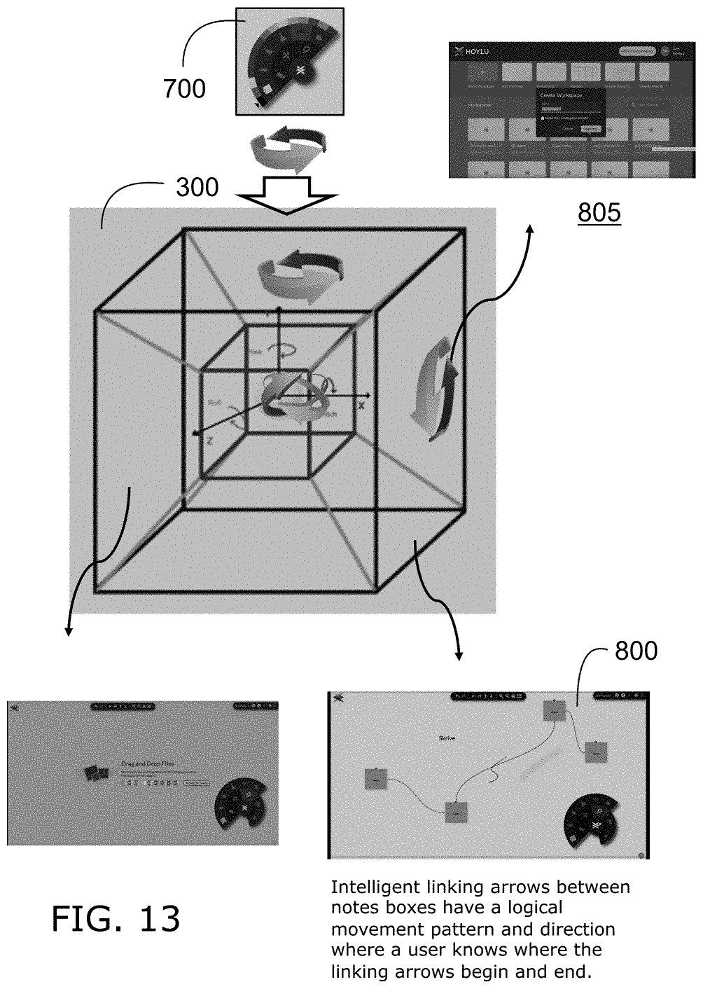

Referring next to FIG. 12, there is shown the aforementioned menu 700, wherein the menu 700 can be represented in a graphical user interface (GUI) with various options shown as components arranged in a ring 750 therearound. As an alternative to using the menu 700 and its ring 750, the aforesaid tesseract indicated generally by 300 can be used. Beneficially, rather than representing the options as the ring 750, the options in that tesseract 300 are provided on facets or layers 200 of the tesseract 300, wherein the facets or layers 200 surround a central menu object 780 that is optionally depicted as a nuanced form of the menu 700. The facets or layers 200 are populated by those options that are most frequently invoked by the user, whereas less frequently used options are invoked by the user searching into sub-facets of the tesseract 300; such sub-facets lie deeper within the tesseract 300. Thus, contents of the facets or layers 200 are dynamically changing in response to a manner in which the user operates the aforesaid software application, for example the “workspace” application. Referring next to FIG. 13, the aforesaid menu 700 is implement in the software application as, for example, the tesseract 300, wherein various work planes can be invoked, for example a plane denoted by 800 on which the aforesaid elements and their linking arrows are presented; the elements and their linking arrows are conveniently editable on the work plane. Other work planes can be invoked that provide access to various components, for example documents, drawings, videos and so forth, as depicted by rectangular symbols arranged in a tiled or array format as denoted by 805.

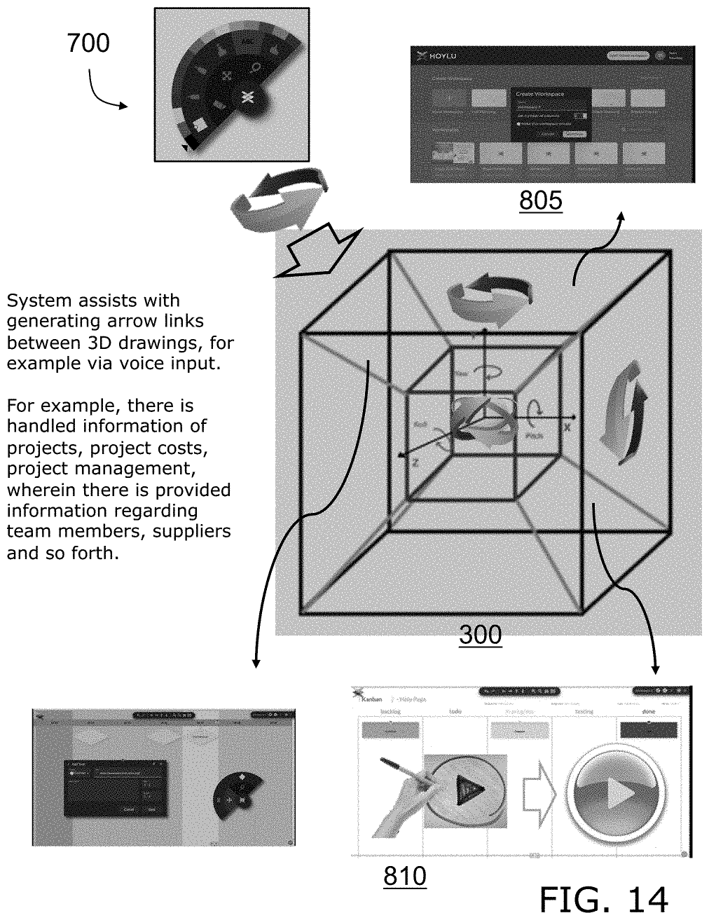

Referring next to FIG. 14, the tesseract is optionally manipulable using voice functions, for example “rotate left”, “rotate right”, “rotate up”, “rotate down” using suitable voice recognition software that is executable on computing hardware that generates the tesseract 300 on the aforesaid GUI. Certain planes of the workspace application can provide for diagram sketching as denoted by 810, for representing team members of a given project, for playing multimedia files representative of details of a given project (for example, video presentations, video clips and so forth). Such options are readily accessible to a given user by rotating the tesseract and invoking a given facet or layer 200 of the tesseract 300.

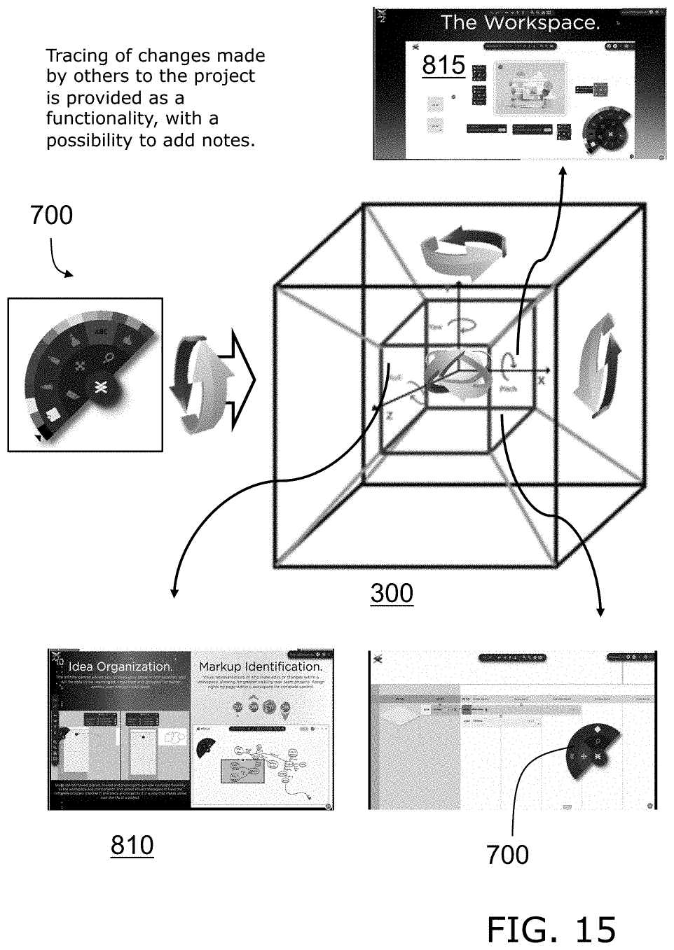

In FIG. 15, there is shown an illustration of the menu 700 represented by the tesseract 300, wherein the tesseract 300 can be used as an alternative for the aforesaid menu 700. The tesseract 300 enables other users to use and interact with the aforesaid workspace platform, thereby making possible for documents, project plans, interrelationships and so forth to be interrogated and edited as required.

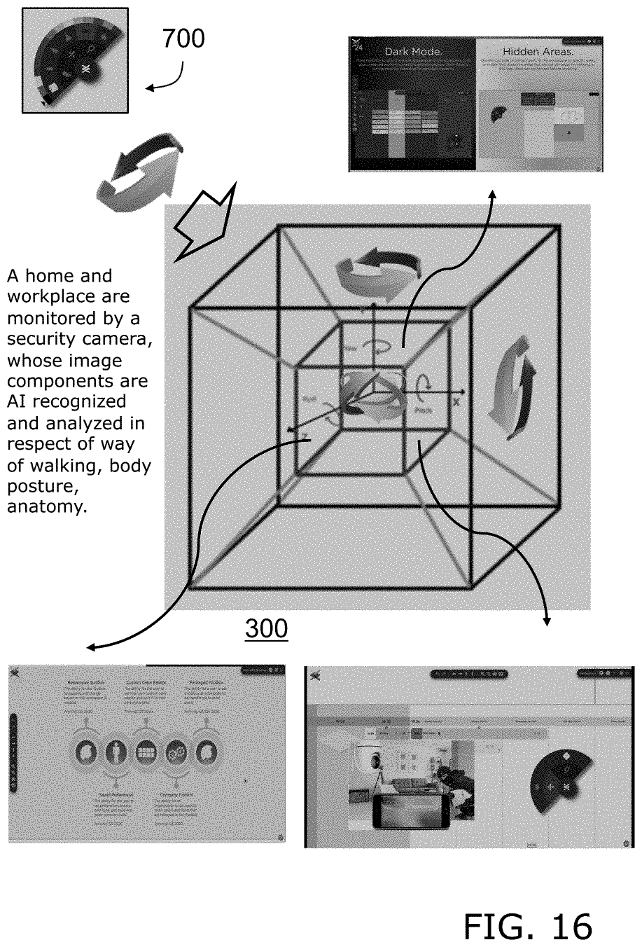

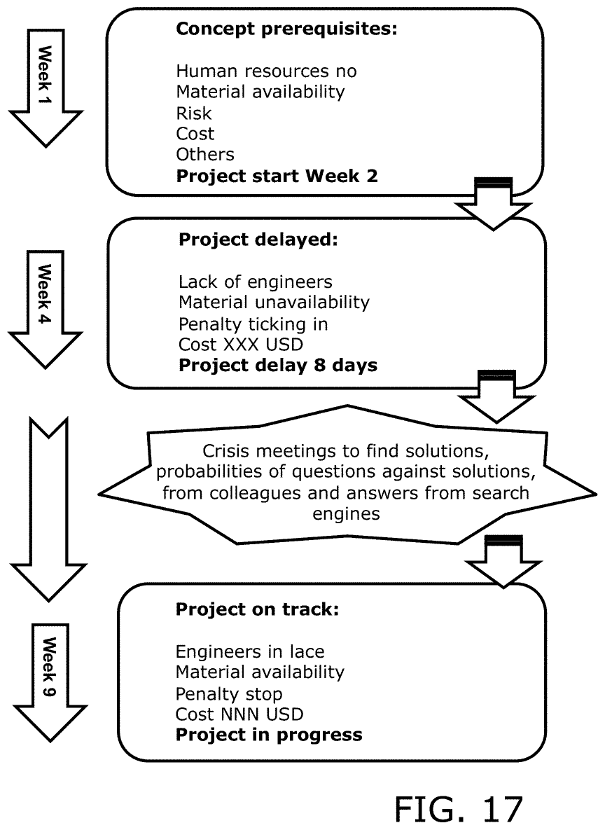

Referring next to FIG. 16, the tesseract 300 can be used by a given user to invoke specialist functions such as security monitoring, audio monitoring, intruder alarms, and for analyzing recorded video records acquired from surveillance cameras, surveillance microphones and so forth. Conveniently, such specialist functions are also supporting via the aforesaid “workspace” platform. For example, in FIG. 17, there is shown an illustration of a flowchart that can be generated using the “workspace” platform to monitor progress being made in respect of a given project; in an event of the given project experiencing delays at week 4 of its implementation, the platform is configured to schedule a crisis meeting at week 4 to resolve the delays, with a result that the given project is progressing satisfactory again at week 8 of the given project. The workspace platform is arranged to present key parameters and metrics required for monitoring progress of the given project, so that a team involved has all parameters and metrics available for the crisis meeting.

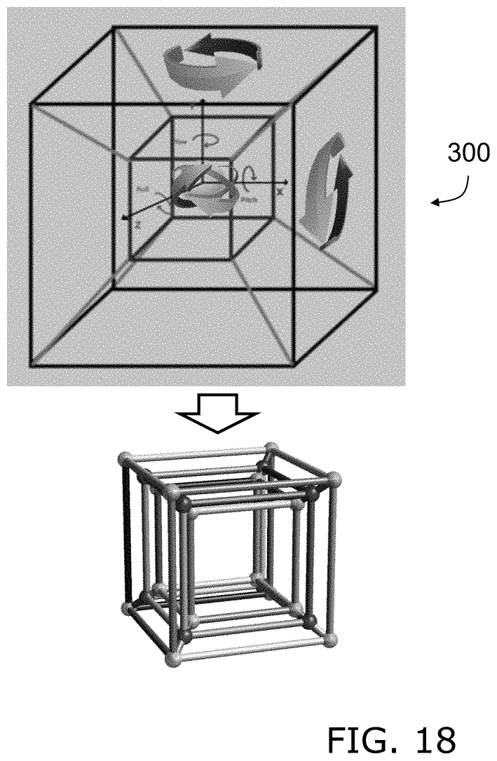

Conveniently, as shown in FIG. 18, the tesseract is a representation as a nested multi-faceted structure, wherein in a software-generated environment, the tesseract 300 can be user-manipulated, for example rotated about various axes, for example in response to user voice instructions. Facets or layers of the tesseract 300 represent various options, functions and actions that a given user can invoke. As aforementioned, facets or layers 200 of the tesseract 300 at a top level are dynamically varied in response to a temporal frequency in which the facets are user-invoked.

The tesseract 300 is beneficially used as a representation for an artificial intelligence engine. An artificial intelligence engine is a specialist software product that is executable on computing hardware, wherein the artificial intelligence engine includes a simulation of a neural network, wherein feedback is beneficially configured around the neural network so that the neural network is able to implement decision states. An artificial intelligence engine receives input information and takes various decisions based upon various learned rules. The rules are optionally developed by the artificial intelligence engine in response to the artificial intelligence engine being presented with teaching data. Conveniently, the artificial intelligence engine is implemented using a recursive neural network.

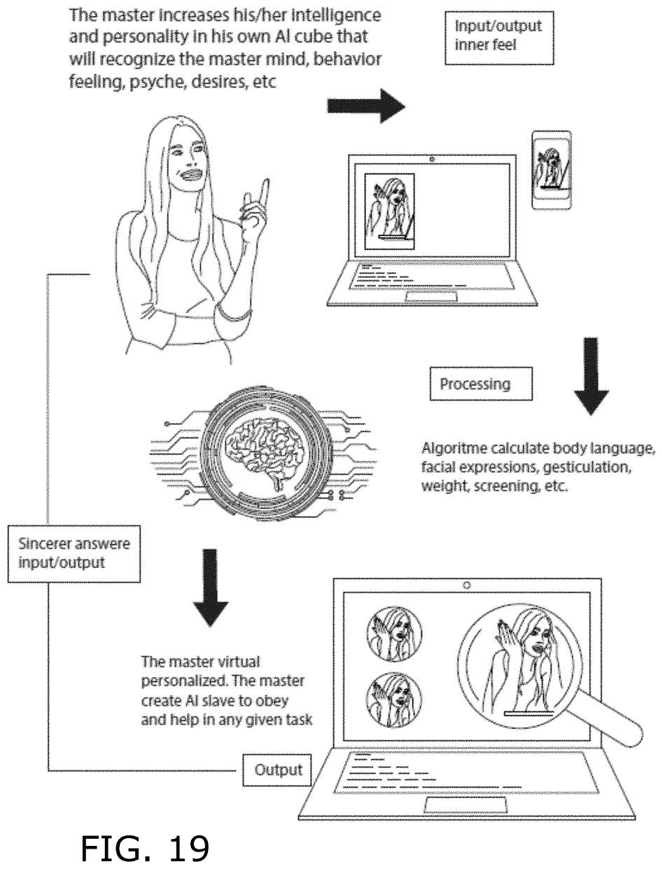

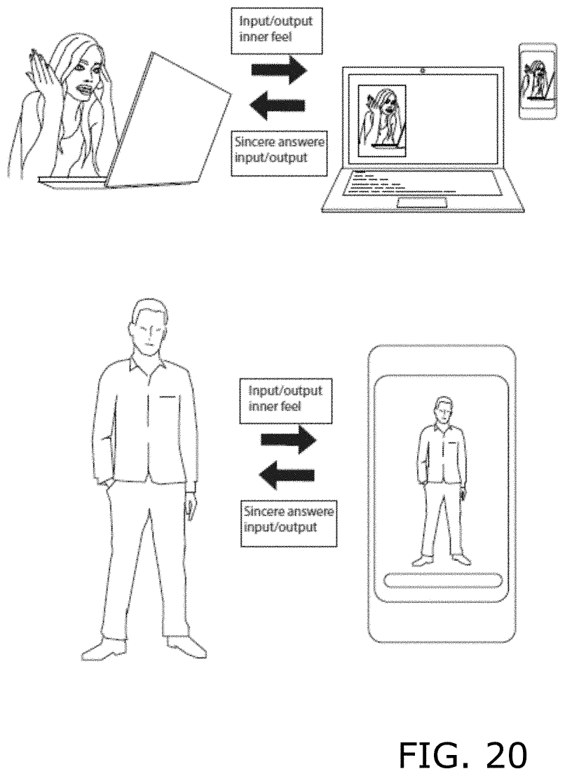

Referring next to FIG. 19, the tesseract 300 and its associated artificial intelligence engine are useable in the aforesaid workspace platform. Moreover, the tesseract 300 when linked to the artificial intelligence engine is also useable for personal training purposes. The tesseract 300 is thus capable of functioning as an “AI cube”. The AI cube is provided with a given user's information, images of posture of the given user, responses provided by the given user to interrogating questions, as well as other data gathered from the given person (for example, weight). Based upon the given person's information received by the artificial intelligence engine, the tesseract 300 is representative of a portal with the given user linking the given user to the artificial intelligence engine. Via the tesseract 300, the artificial intelligence engine is able to provide personal advice and training to the given user. By providing intelligent support, the artificial intelligence engine is capable of functioning as a mentor to assist individuals with personality building, counselling, mental depression treatment and so forth. Conveniently, as depicted in FIG. 20, in a graphical user interface, for example provided via a smart phone or a personal computer, or both, the tesseract 300 can provide for various types of human interaction, for example via selective video conferencing. Moreover, as aforesaid, the tesseract 300 is able to function as a portal for an artificial intelligence (AI) engine. The AI engine is able to supervise human interactions, make introductions between people, and also provide feedback regarding human appearance, for example for promoting good posture, good manners, good diction, advice regarding suitable clothing to wear, and so forth. As human interactions are complex, the tesseract 300 is especially suitable for representing complex details of human personality on facets or layers 200 of the tesseract 300.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A user interface apparatus including a computer arrangement coupled to a data memory arrangement for processing, accessing and storing data, and a display arrangement for receiving graphics data from the computer arrangement to present as graphical images to a user,
wherein
the computer arrangement, when in operation, instructs the display arrangement to present at least one tesseract with overlayed icons onto facets or layers of the at least one tesseract that represent a menu of executable options that can be invoked by the user.

2. The user interface apparatus of claim 1, wherein the overlayed icons on neighbouring facets or layers of the at least one tesseract are related by a similarity of nature of data that their icons represents, and a likely temporal sequence in which the icons are to be invoked by the user when using the apparatus.

3. The user interface apparatus of claim 2, wherein the at least one tesseract is displayed on the display arrangement in 2-dimensions, wherein the at least one tesseract represents more than 3-dimensions in its geometric structure.

4. The user interface apparatus of claim 2, wherein the at least one tesseract, when displayed via the display arrangement, is susceptible to being rotated in response to feedback provided to the user interface apparatus by the user.

5. The user interface apparatus of claim 4, wherein the feedback provided to the user interface apparatus by the user includes at least one of: touch feedback provided via the display arrangement when implemented using a touch screen with tactile sensing, oral feedback captured using a microphone of the apparatus, gesture feedback of the user captured via use of a camera of the user interface apparatus.

6. The user interface apparatus of claim 1, wherein data used by the user interface apparatus is stored in the data memory arrangement according to icons on neighbouring facets or layers of the at least one tesseract that is presented, when the user interface apparatus is in operation, on the display arrangement.

7. The user interface apparatus of claim 1, wherein the user interface apparatus is configured to implement a workspace platform for user interaction wherein the workspace platform, when executed in operation, provides a presentation plan in which a plurality of elements are representative of projects, parts of projects, information supporting projects, and wherein one or more linking arrows are included on the plan to represent interrelationships between the elements.

8. The user interface apparatus of claim 7, wherein at least one of the elements, the linking arrows and the information supporting projects is user-editable via the workspace platform.

9. The user interface apparatus of claim 7, wherein the workspace platform is configured to support multiple users that are able mutually interactively to access and interrogate the work platform.

10. A method for operating a user interface apparatus including a computer arrangement coupled to a data memory arrangement for processing, accessing and storing data, and a display arrangement for receiving graphics data from the computer arrangement to present as graphical images to a user,
wherein the method includes:
arranging for the computer arrangement, when in operation, to instruct the display arrangement to present at least one tesseract with overlayed icons onto facets of the at least one tesseract that represent a menu of executable options that can be invoked by the user.

11. The method of claim 10, wherein the method includes relating overlayed icons on neighbouring facets or layers of the at least one tesseract by a similarity of nature of data that their icons represents, a likely temporal sequence in which the icons are to be invoked by the user when using the user interface apparatus.

12. The method of claim 11, wherein the method includes displaying the at least one tesseract on the display arrangement in 2-dimensions, wherein the at least one tesseract represents more than 3-dimensions in its geometric structure.

13. The method of claim 11, wherein the method includes arrangement for the at least one tesseract, when displayed via the display arrangement, to be susceptible to being rotated in response to feedback provided to the user interface apparatus by the user.

14. The method of claim 13, wherein the feedback provided to the user interface apparatus by the user includes at least one of: touch feedback provided via the display arrangement when implemented using a touch screen with tactile sensing, oral feedback captured using a microphone of the user interface apparatus, gesture feedback of the user captured via use of a camera of the user interface apparatus.

15. The method of claim 10, wherein the method includes storing data used by the user interface apparatus in the data memory arrangement according to icons on neighbouring facets or layers of the at least one tesseract that is presented, when the user interface apparatus is in operation, on the display arrangement.

16. The method of claim 10, wherein the method includes configuring the user interface apparatus to implement a workspace platform for user interaction wherein the workspace platform, when executed in operation, provides a presentation plan in which a plurality of elements are representative of projects, parts of projects, information supporting projects, and wherein one or more linking arrows are included on the plan to represent interrelationships between the elements.

17. The method of claim 16, wherein at least one of the elements, the linking arrows links and the information supporting projects is user-editable via the workspace platform.

18. The method of claim 16, wherein the method includes configuring the workspace platform to support multiple users that are able mutually interactively to access and interrogate the workspace platform.

19. A computer program product comprising a non-transitory computer-readable storage medium having computer-readable instructions stored thereon, the computer-readable instructions being executable by a computerized device comprising processing hardware to execute a method
for operating a user interface apparatus including a computer arrangement coupled to a data memory arrangement for processing, accessing and storing data, and a display arrangement for receiving graphics data from the computer arrangement to present as graphical images to a user,
wherein the method includes:
arranging for the computer arrangement, when in operation, to instruct the display arrangement to present at least one tesseract with overlayed icons onto facets of the at least one tesseract that represent a menu of executable options that can be invoked by the user.

20. A computer program product of claim 19, characterized in that the computer program product includes machine learning (ML)/artificial intelligence (AI) software products to provide customization of a user interface apparatus to characteristics of its user, the interface apparatus including a computer arrangement coupled to a data memory arrangement for processing, accessing and storing data, and a display arrangement for receiving graphics data from the computer arrangement to present as graphical images to a user,
wherein
the computer arrangement, when in operation, instructs the display arrangement to present at least one tesseract with overlayed icons onto facets or layers of the at least one tesseract that represent a menu of executable options that can be invoked by the user.
